(19) United States
(12) Patent Application Publication
(10) Pub. No.: US 2014/0202758 A1
(43) Pub. Date: Jul. 24, 2014

(54) ADJUSTABLE RING FOR JUNCTION BOXES

(71) Applicant: Christopher M. Lolachi, Rancho Palos Verdes, CA (US)

(72) Inventor: Christopher M. Lolachi, Rancho Palos Verdes, CA (US)

(21) Appl. No.: 14/240,731

(22) PCT Filed: Aug. 23, 2012
(86) PCT No.: PCT/US2012/052077

§ 371 Date: Feb. 24, 2014

Related U.S. Application Data
(60) Provisional application No. 61/526,369, filed on Aug. 23, 2011.

(51) Int. Cl. H02B 1/40; F16B 17/00

(52) U.S. Cl. CPC H02B 1/40; F16B 17/00
USPC 174/481; 403/376; 403/327; 29/592.1

(57) ABSTRACT

An adjustment device to accommodate different wall thicknesses for use with a junction box having a front face with an opening therein comprises an assembly and a sleeve. The assembly comprises a plate, a collar extending forwardly from the front face of the plate, and a releasable retainer supported by the collar. The sleeve is slidably mounted in the collar and is retained therein in a selected position by the retainer, which can be a rotatable cam. The cam can be a spring biased to a locking position for locking the sleeve in the collar.

### CROSS-REFERENCE TO RELATED APPLICATION

This application claims priority from and the benefit of Provisional Patent Application Ser. No. 61/526,369, filed Aug. 23, 2011, which is incorporated herein by reference.

### BACKGROUND

This invention relates to the electrical wiring in construction of commercial, industrial, and residential buildings. Electrical junction boxes are used to terminate an electrical conduit in a structure frame. Safety and building codes require a metal cover (ring) closing the electrical junction when it is installed. Further, the metal cover accommodates a variety of electrical switches and receptacles. Conventional rings have a fixed protrusion where they receive the electrical switches and receptacles. Drywalls or other wall surfaces cover the junction box with an opening for a ring extension. There are a range of rings with different sizes of extended cutouts and protrusion that correlate with the thickness of the finished wall.

There are a number of adjustable plaster rings in the market that can replace all different sizes of the conventional cover rings. This invention offers a less expensive and more robust method of adjusting the plaster ring to the final finished surface of the wall in new constructions or future retrofits.

### SUMMARY

The present invention is directed to a device that provides adjustability of a plaster ring to a final finished surface of a wall and new construction that is less expensive and more robust than prior adjustable plaster rings. It is useful for junction boxes having a front face with an opening therein. It comprises a plate having a front face and a rear face, the rear face being for mounting on the front face of the junction box, the plate having a plate opening for placement over the junction box opening. A protrusion, also referred to as a collar, extends forwardly from the front face of the plate and a releasable retainer is supported by the protrusion. A sleeve that serves as an adjustable ring extender is slidably mounted in the protrusion and retained therein in a selected position by the retainer. The retainer is “releasable” because it can be moved between a position that locks the sleeve in place and a position that releases the sleeve for adjustment.

Optionally, the assembly comprises a spring that biases the retainer toward the sleeve.

The retainer, which can be a cam, has a first position for locking the sleeve in the protrusion and a second position for releasing the sleeve from the protrusion and is rotatable between the first and second positions.

The sleeve is generally rectangular with a peripheral wall comprising opposed first and second parallel segments and opposed third and fourth parallel segments that are each perpendicular to the first and second segments. There is a first corner segment between the first and second segments on which the cam presses. The sleeves can include a second corner segment opposite the first corner segment for secure mounting of the sleeve in the protrusion.

Typically, the device comprises a support, such as a bracket or caddy for the cam, where the support is welded to the protrusion.

A method of using the device comprises placing the plate of the assembly on the front face of the junction box and sliding the sleeve into the protrusion to a first selected position depending upon the wall thickness. Where the device includes a biasing spring, the sleeve is automatically locked into position. In the version without a spring, the cam is rotated to a locking position for retaining a sleeve in the ring in the first selected position.

If it is desirable to adjust the position of the sleeve or remove it, the cam can be rotated to a release position, and then the sleeve is placed in a second selected position different from the first selected position, and the cam is then rotated to the locking position.

### DRAWINGS

These and other features, aspects, and advantages of the present invention will become better understood with reference to the following description, dependent claims, and accompanying drawings where:

FIG. 1 is a perspective view of a first version of a device having features of the present invention, for mounting electrical devices on a junction box with an optional extension;

FIG. 2A is a perspective view of the retainer of the device of FIG. 1;

FIG. 2B is an exploded perspective view of the retainer of FIG. 2A;

FIG. 3 is a front elevation view of the device of FIG. 1;

FIG. 4 is a front elevation view of region 4 in FIG. 3 showing the retainer in a release position;

FIG. 5 shows region 4 of FIG. 3 with the retainer in a locked position;

FIG. 6 is an exploded perspective view of a second version of a device having features of the present invention;

FIG. 7 is a perspective view of the device of FIG. 6 assembled;

FIG. 8 is an exploded perspective view of a third version of a device having features of the present invention;

FIG. 9 is an exploded perspective view, partly assembled, of the device of FIG. 8;

FIG. 10A is a front plan view of the device of FIG. 8 with the retainer in a locked position;

FIG. 10B shows detailed region 10B in FIG. 10A;

FIG. 11A is a front plan view of the device of FIG. 8 with the retainer in an unlocked position;

FIG. 11B shows detailed region 11B in FIG. 11A;

FIG. 12 is a perspective view of a fourth version of the device having features of the present invention;

FIG. 13 is a perspective view of the retainer of the device of FIG. 12;

FIG. 14 is an exploded perspective view of the retainer of FIG. 13;

FIG. 15 is a perspective view of the retainer and collar of the device of FIG. 12 in a non-locking position;

FIG. 16 shows region 16 of FIG. 15 with the retainer in a locked position;

FIG. 17 shows a portion of region 16 of FIG. 15;

FIG. 18 is a perspective view of the retainer and the sleeve of the device of FIG. 12 in an unlocked position;

FIG. 19 shows region 19 of FIG. 18 with the retainer in the unlocked position;

FIG. 20 shows a portion of region 19 of FIG. 18 with the retainer in the unlocked position;

FIG. 21 is a front plan view of a fifth version of a device having features of the present invention; and

FIG. 22 shows in detail the region 22 of FIG. 21.

### DESCRIPTION

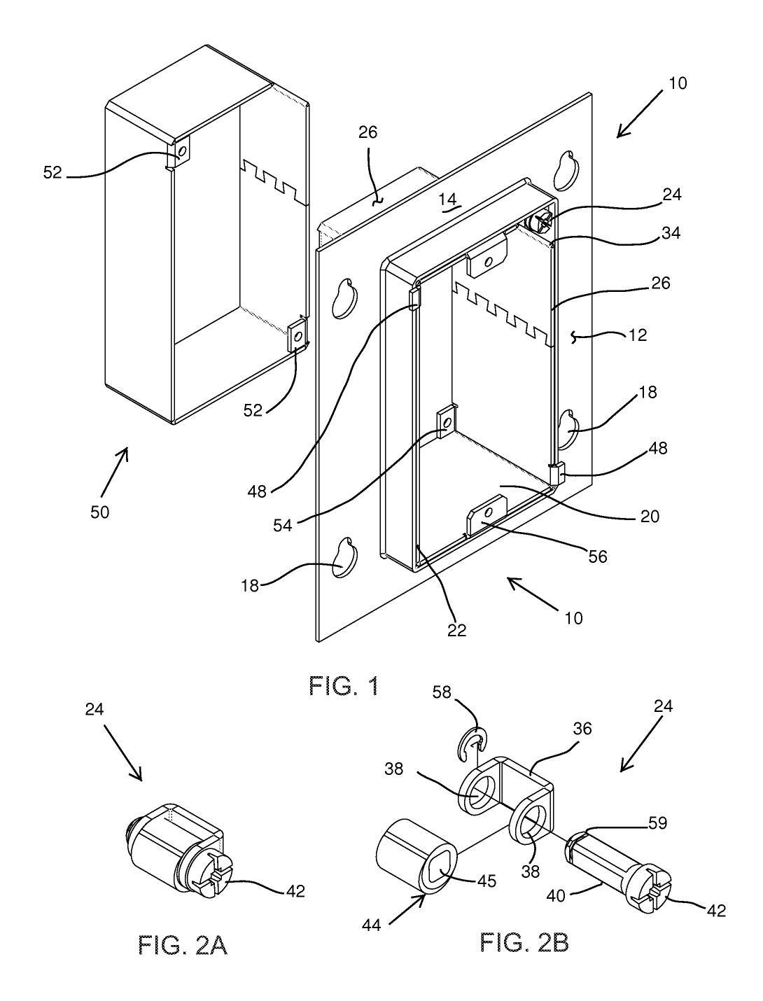

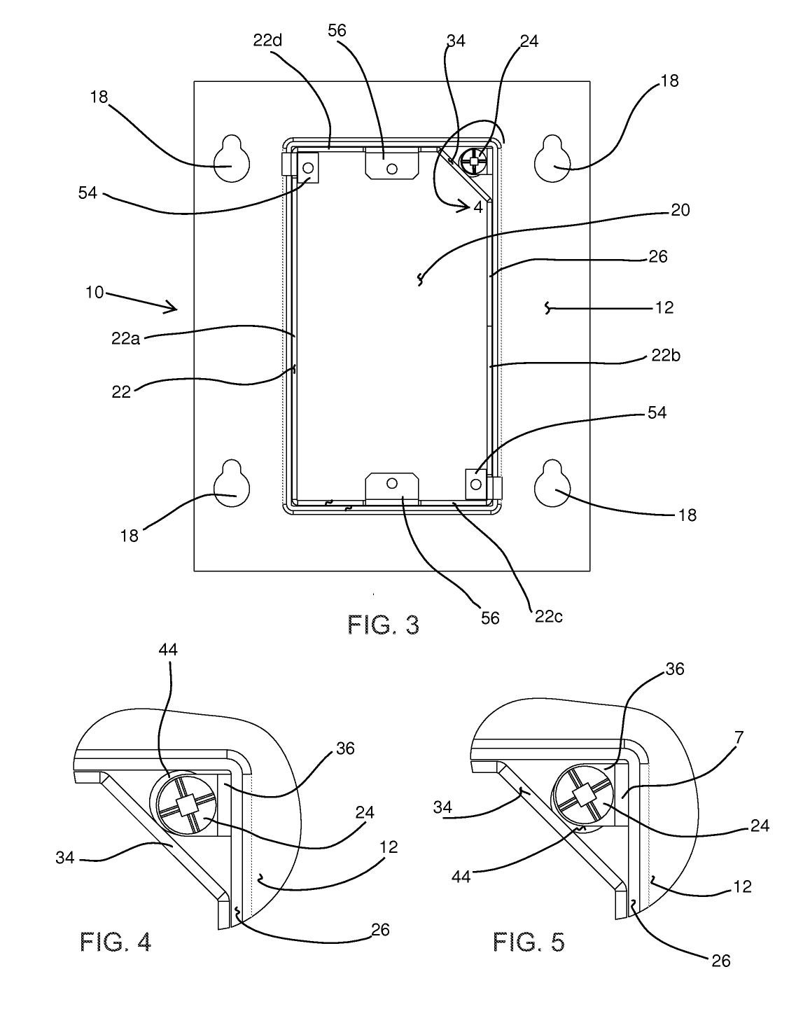

With reference to FIGS. 1-5, an adjustable ring device 10 for junction boxes according to a first version of the invention is adapted for mounting on a junction box (not shown) having a front face with an opening therein. A typical junction box is mounted on a stud or otherwise placed in a location that will be within a wall. A purpose of this invention is to allow the junction box, without having to be remounted, to be used with different wall thicknesses.

The device 10 comprises a plate 12 having a front face 14 and an opposed rear face wherein the rear face is for mounting on the front face of the junction box. The plate 12, which is generally rectangular in configuration, has four cutouts 18 to be mounted on mounting parts of the junction box. There is a generally centrally located plate opening 20 that is generally sized to be in register with the corresponding opening in the junction box. Surrounding the plate opening 20 is a protrusion 22, also referred to as a collar, extending forwardly from the front face 14 of the plate 12. A retainer 24 is supported by the protrusion 22. A sleeve 26, also referred to as a slider is slidably mounted in the protrusion 22 and retained therein a selected position by the retainer 24.

Both the sleeve 26 and the collar 22 are generally rectangular in configuration. The sleeve 26 has a peripheral wall comprising opposed first 22a and second 22b parallel wall segments and opposed third 22c and fourth 22d parallel wall segments, the third and fourth segments being perpendicular to the first and second segments. In addition, there is a first corner segment 34 between the first and third segments. The retainer 24 presses against this corner segment 34 to lock the sleeve 26 in the protrusion 22.

As best shown in FIG. 2B, the retaining mechanism 24 comprises a mounting support such as a bracket or caddy 36 secured to the protrusion 22 such as by welding, the caddy 36 having aligned openings 38 through which a bolt 40 extends. The bolt 40 has a slotted head 42 for rotation by a torque device such as a screwdriver (not shown). A cam 44 having an axially extending opening 45 is mounted on the shaft of the bolt 40. The exterior surface of the bolt shaft, the interior surface of the cam opening 45 are configured so that rotation of the bolt 40 results in rotation of the cam 44. Thus the cam 44 engages the slanted corner segment 34 of the sleeve, when moved by the torque movement such as a screwdriver to a locked position as shown in FIG. 5, moving from an unlocked position as shown in FIG. 4.

The forward edge of the sleeve 26 optionally can have a plurality of outwardly extending tabs 48 to limit the distance the sleeve 26 can be positioned in the protrusion 22, thereby preventing the sleeve 26 from sliding completely through the protrusion into the junction box.

Optionally, as shown in FIGS. 1, and an extension 50 can be provided to accommodate additional versatility in depth adjustment. The extension 50 can be attached and detached through tabs 52 it has on its forward edge to corresponding tabs 54 on the collar with fasteners 55.

The sleeve 26 has mounting tabs 56 extending inwardly toward each other into the opening 20 of the protrusion 22 for attachment of electrical devices, such as switches or receptacles.

The device 10 has the capability of readjustment after installation in case of future remodeling or modification of the wall thicknesses. To do that, the cam 44 is turned to the unlocked position as shown in FIG. 4 to readjust the placement of the sleeve 26. The cam 44, in the locked position, is very stable in adhering to the locking spot.

To hold the bolt 40 in position in the caddy 36, a clip 58 can be provided for placement in a groove 59 at the end of the bolt shaft.

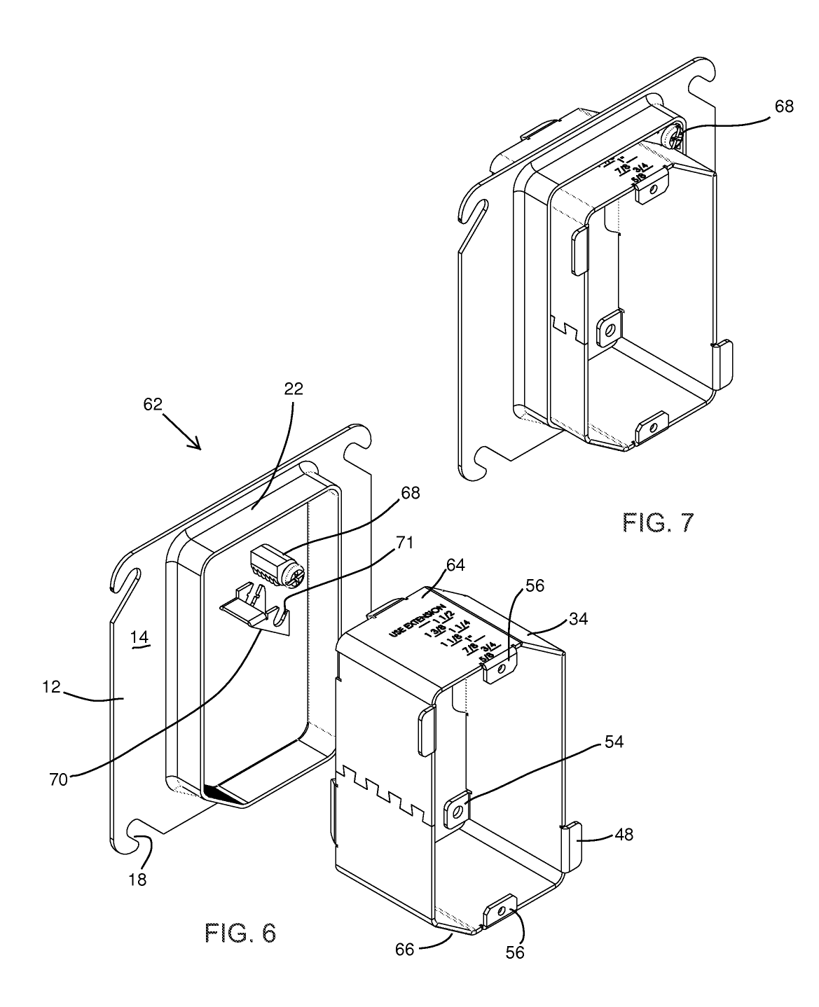

With reference to FIGS. 6 and 7, a device 62 according to a second version of the invention, differs from the device of FIG. 1 in two principal ways. First, a sleeve 64 has a second corner segment 66 opposite the first corner segment 34, and is, slanted at substantially the same angle such as about 45 degrees relative to the adjoining wall segments. This results in better locking of the sleeve 64 in the protrusion 22. Second, a retainer 68 is used having the bolt and the cam integrated into a single unit, reducing manufacturing costs. This construction requires a caddy 70 with slotted openings 71 to provide a cradle like device instead of the aligned holes 38 of the caddy 36.

As shown in FIG. 6, an outside surface 72 of the sleeve 64 can have markings thereon corresponding to different wall thicknesses to assist the user in sliding the sleeve to the appropriate depth depending on surrounding wall thickness. The last marking states “use extension” for when the wall is so thick that an extension 50 is needed.

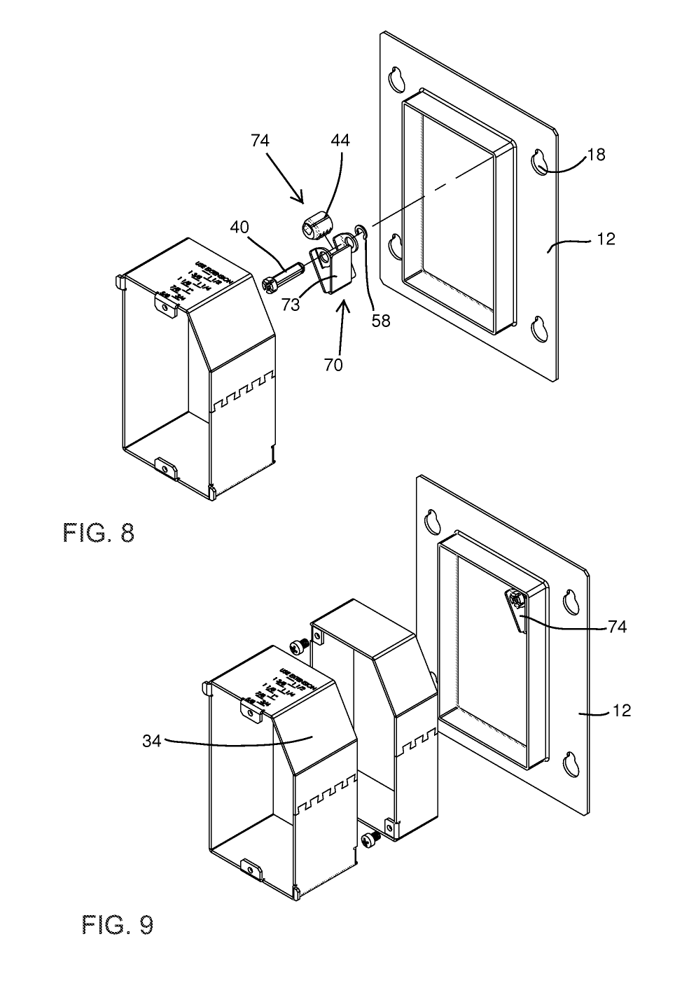

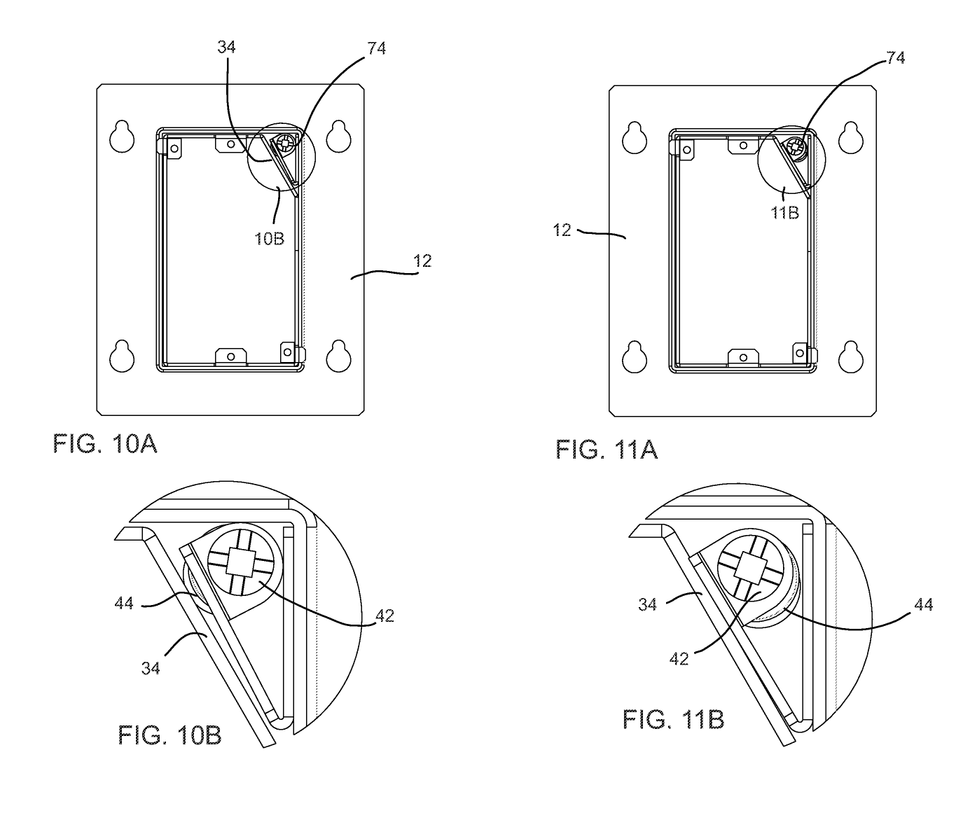

In a third version of the invention, as shown in FIGS. 8-11, a retainer 74 is similar to the retainer 24 used in the version in FIG. 1, likewise having a rotatable bolt 40 over which is mounted the cam 44, the bolt 40 being held in a caddy 70 by the clip 58. The caddy 70 has two legs 73 that when pressed toward each other, act as a spring with an outward force, and is biased to press against the first corner segment 34 of the sleeve 26. Thus, when the sleeve is positioned in the protrusion 22, it is not necessary to adjust the retaining mechanism, i.e., the sleeve is automatically locked in position, unlike the version of the invention shown in FIG. 1, where the cam needs to be rotated to the locking position from the second release, or non-locking position.

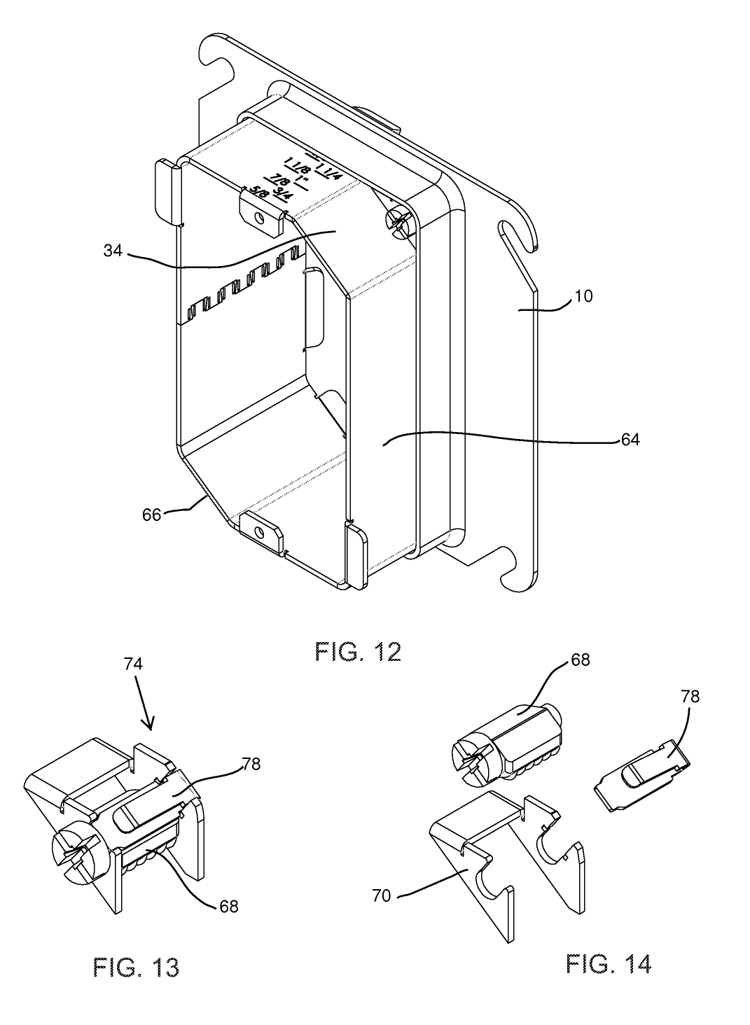

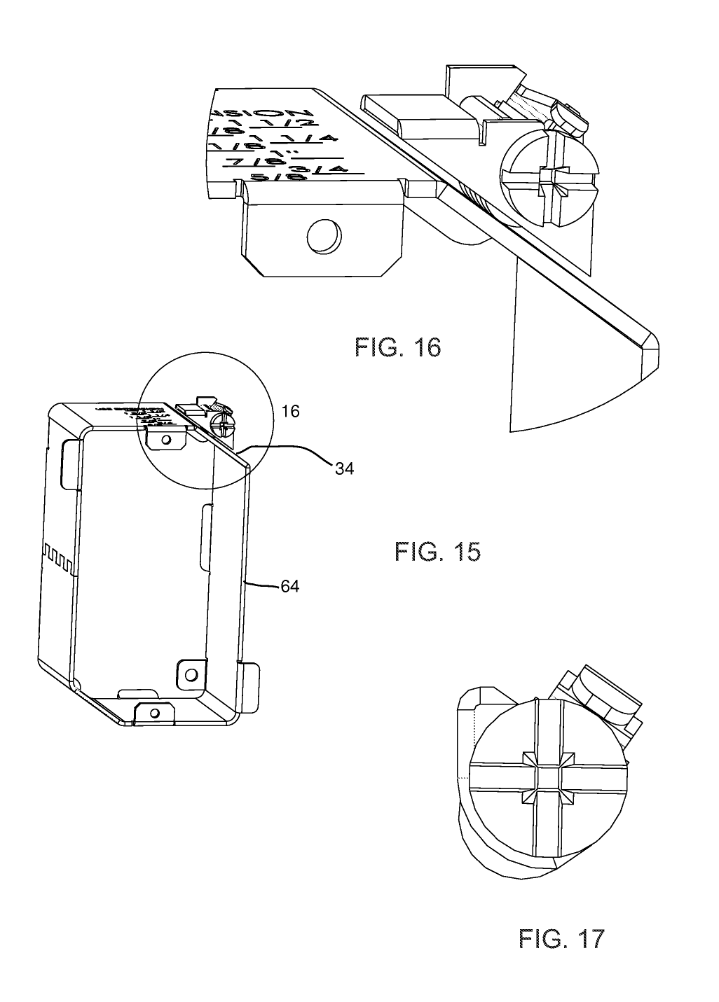

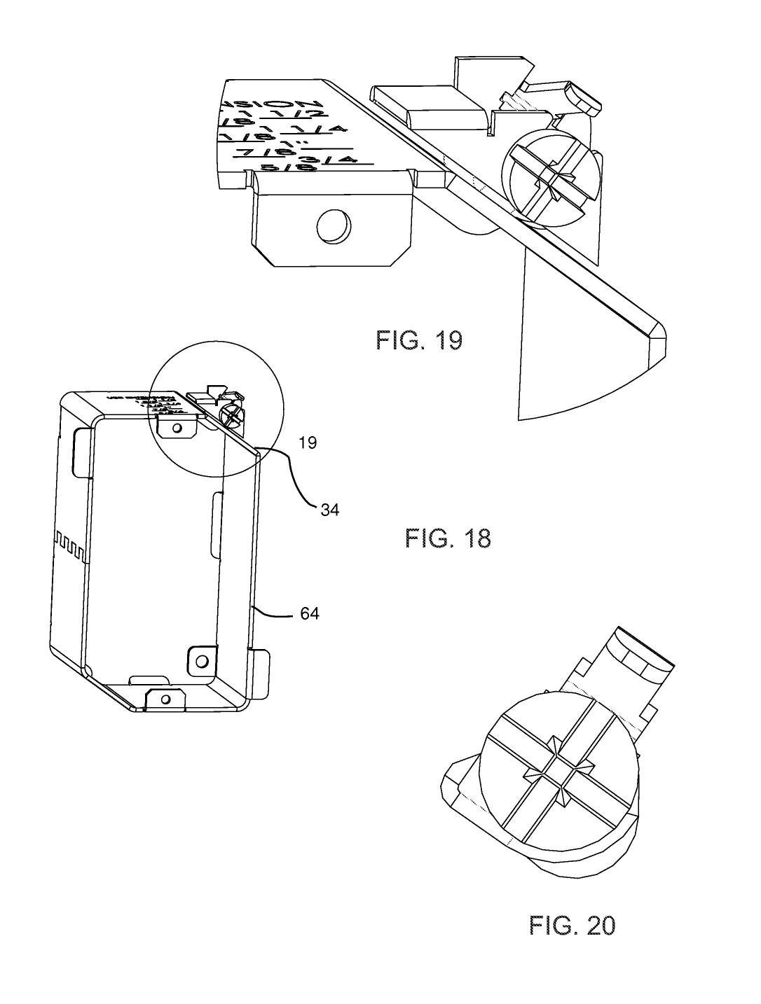

In a fourth version according to the present invention, as shown in FIGS. 12-22, features of versions 2 and 3 are combined. In particular, the retainer 74 utilizes the combined bolt and the cam retainer 68 together is used and the retainer comprises a clip spring 78 for biasing the cam against the sleeve 64 in a locking position. Also, there is a second slanted corner segment 66 for better retention.

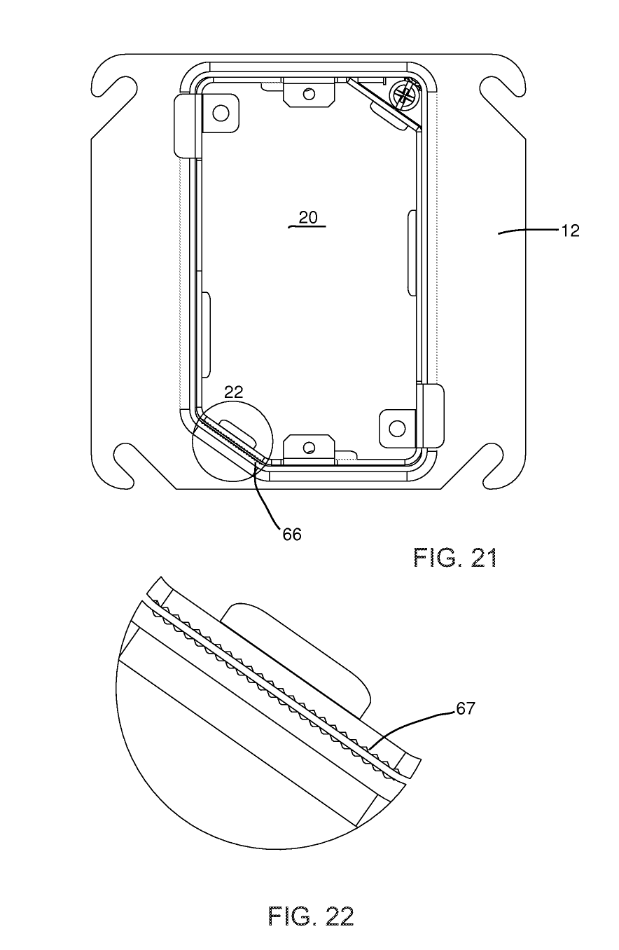

With reference to FIGS. 21 and 22, it is desirable that the second corner wall segment 66 be roughened such as by knurls 67 to increase the engagement between the sleeve 26 and the collar 22 to lock the sleeve into position.

The device of the invention is made with materials conventionally used for plaster rings, and can be made out of plastic or metal.

In use, after the plate 12 is mounted on the junction box, the sleeve 26 is slid into a first selected position inside the collar 22. In the third and fourth version the sleeve, assuming the cam is in the right position, is automatically locked into position. In the first and second versions of the invention is necessary to rotate the cam from an unlocked position to a locking position. If it is desirable to remove the sleeve or adjust its position from a first selected position, this is easily accomplished by rotating the cam to the unlocked position, moving the sleeve to a second selected position, and then rotating the cam to its locked position.

Although the present invention has been described in considerable detail with reference to certain preferred versions thereof, other versions are possible. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless each feature disclosed is one example only of a generic series of equivalent or similar features.

1. A device for mounting on a junction box having a front face with an opening therein, the device comprising:
a) an assembly comprising:
i) a plate having a front face and a rear face, the rear face being for mounting on the front face of the junction box , the plate having a plate opening for placement over the junction box opening;
ii) a protrusion extending forwardly from the front face of the plate; and
iii) a releasable retainer supported by the protrusion; and
b) a sleeve slidably mounted in the protrusion and retained therein in a selected position by the retainer.

2. The device of claim 1 wherein the assembly comprises a spring biasing the retainer toward the sleeve.

3. The device of claim 1 wherein the retainer has a first position for locking the sleeve in the protrusion and a second position for releasing the sleeve from the protrusion.

4. The device of claim 3 wherein the retainer is rotatable between the first and second positions.

5. The assembly of claim 4 wherein the retainer comprises a cam.

6. The device of claim 5 wherein the sleeve is generally rectangular with a peripheral wall comprising opposed first and second parallel segments and opposed third and fourth parallel segments perpendicular to the first and second segments, and a first corner segment between the first and third segments against which the cam presses.

7. The device of claim 6 comprising a second corner segment opposite the first corner segment.

8. The device of claim 5 comprising a support for the cam.

9. The device of claim 8 wherein the support is welded to the protrusion.

10. The device of claim 1 mounted on a junction box.

11. A method for mounting an electrical device in a junction box comprising (a) placing the plate of the assembly of claim 1 on the front face of the junction box and (b) sliding a sleeve into the protrusion into a first selected position.

12. The method of claim 11 wherein the retainer comprises a cam rotatable between a locking position for locking the sleeve in the protrusion and a release position for releasing the sleeve from the protrusion.

13. The method of claim 12 wherein the method comprises after step (b) rotating the cam to the locking position for retaining the sleeve in the protrusion in the first selected position.

14. The method of claim 13 comprising the additional steps of rotating the cam to the release position and sliding the sleeve in the protrusion to a second selected position different from the first selected position, and thereafter rotating the cam to the locking position for retaining the sleeve in the protrusion in the second selected position.

15. The method of claim 11 wherein the assembly comprises a spring a spring biasing the retainer toward the protrusion and the cam is in a locking position and step (b) results in the cam automatically retaining the sleeve in the protrusion in a first selected position without rotating the cam.

16. The method of claim 15 comprising the additional step of rotating the cam to a release position and sliding the sleeve in the protrusion so a second selected position different from the first selected position and thereafter rotating the cam to the locking position for retaining the sleeve in the protrusion in the second selected position.

17. The method of claim of claim 11 comprising adding an extension to the sleeve.

18. The device of claim 1 comprising an extension attached to the sleeve.
